(19) United States
(12) Patent Application Publication
(10) Pub. No.: US 2010/0147608 A1
(43) Pub. Date: Jun. 17, 2010

(54) MOVABLE BODY

(76) Inventor: Hiroki Okabe, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/600,281

(22) PCT Filed: May 21, 2008
(86) PCT No.: PCT/IB2008/001262

§ 371 Date: Nov. 16, 2009

(30) Foreign Application Priority Data
May 22, 2007 (JP) 2007 135014

(51) Int. Cl. B60L 11/18; B23P 11/00

(52) U.S. Cl. 180/65.31; 29/428

(57) ABSTRACT

A movable body includes a fuel cell stack (100) and structural bodies (110, 111, 132 and 133) that constitute a body or a frame of the movable body. The fuel cell stack (100) includes a power generation stack body (10), two end plates (11 and 12), and clamping members (14b). The movable body further includes first connection portions (120) that connect at least one of the two end plates (11 and 12) to the structural bodies (110 and 111), and second connection portions (130 and 131) that connect the clamping members (14b) to the structural bodies (132 and 133), respectively.

### BACKGROUND OF THE INVENTION

1. Field of the Invention

The invention relates to a movable body in which a fuel cell is mounted.

2. Description of the Related Art

Recently, vehicles provided with a fuel cell stack have drawn much attention. The fuel cell stack generates electric power using hydrogen and oxygen as fuel. The fuel cell stack includes a power generation stack body and end plates. The power generation stack body is formed by stacking a plurality of power generation bodies, each of which functions as a single cell. The power generation stack body is clamped between the end plates in the direction in which the power generation bodies are stacked. Each of the power generation bodies includes a membrane electrode assembly (hereinafter referred to as “MEA”) in which catalytic layers, such as platinum layers, are formed on respective sides of an electrolyte membrane, conductive porous bodies that are disposed on respective sides of the MEA and that function as gas passages, and separators that are disposed on the outer sides of the respective conductive porous bodies.

The fuel cell stack thus structured needs to be mounted in the vehicle in such a manner that the fuel cell stack withstands acceleration/deceleration shock and vibration of the vehicle, that is, the structure formed by mounting the fuel cell stack in the vehicle needs to allow the fuel cell stack to withstand acceleration/deceleration shock and vibration of the vehicle. Japanese Patent Application Publication No. 2006-221854 (JP-A-2006-221854) describes an example of the manner in which a fuel cell stack is mounted in a vehicle. According to JP-A-2006-221854, end plates, between which a power generation stack body is clamped, are fixed to structural members of the vehicle.

However, this technology has the following problem. A shearing force may be generated between the adjacent power generation bodies, which constitute the power generation stack body, due to vibration of the vehicle, etc. This may bring the power generation bodies out of proper alignment. Such a problem may occur not only in a fuel cell vehicle but also in any type of movable body that is provided with a fuel cell.

### SUMMARY OF THE INVENTION

The invention provides a technology that makes it is possible to suppress occurrence of the situation in which the power generation bodies of the fuel cell stack, which is mounted in a movable body, are out of proper alignment due to an impact applied from the movable body or vibration of the movable body.

A first aspect of the invention relates to a movable body including: a fuel cell stack that includes a power generation stack body formed by stacking a plurality of power generation bodies; two end plates between which the power generation stack body is clamped in the direction in which the power generation bodies are stacked; and a clamping member that is provided on a side face of the power generation stack body and that extends between the two end plates in such a manner that the two end plates are firmly connected to each other; a structural body that constitutes a body or a frame of the movable body; a first connection portion that connects at least one of the two end plates to the structural body; and a second connection portion that connects the clamping member to the structural body.

In the movable body structured as described above, at least one of the two end plates is connected to the structural body, which constitutes the body or the frame of the movable body, via the first connection portion. Therefore, it is possible to fix the fuel cell stack to the movable body. Further, the clamping member, the second connection portion, and the structural body, which constitutes the body or the frame of the movable body, restrict movement of the power generation bodies in such a direction that the power generation bodies are out of proper alignment. Accordingly, it is possible to suppress occurrence of the situation in which the power generation bodies of the fuel cell stack, which is mounted in the movable body, are out of proper alignment due to an impact applied from the movable body or vibration of the movable body.

In the movable body according the aforementioned aspect, a plurality of the clamping members, each of which has a rod-shape, may be provided. Alternatively, the clamping member may be a flat plate-shaped member.

A plurality of the second connection portions may be provided at positions that are symmetrical with respect to the fuel cell stack so that the second connection portions face each other across the fuel cell stack.

With the aforementioned structure, it is possible to support the fuel cell stack in a balanced manner even if impacts are applied to the fuel cell stack in various directions, or a force, which acts in the direction opposite to the direction in which the impact applied, is applied to the fuel cell stack in reaction to the impact applied. As a result, it is possible to suppress occurrence of the situation in which the power generation bodies of the fuel cell stack are out of proper alignment.

The power generation bodies may be stacked in the direction parallel to the direction in which the movable body travels to form the power generation stack body. Alternatively, the power generation bodies may be stacked in the direction perpendicular to the direction in which the movable body travels to form the power generation stack body.

With the aforementioned structures, it is possible to suppress occurrence of the situation in which the power generation bodies of the fuel cell stack, which is mounted in the movable body, are out of proper alignment due to an impact applied from the movable body or vibration of the movable body.

Further, the structural body may include a pair of side members, a cross member that extends between the side members, and a partition that is provided between the side members; and the first connection portion may connect at least one of the two end plates to the cross member; and the second connection portion may connect the clamping member to the partition.

Further, at least one of the first connection portion and the second connection portion may be made of metal. Also, the clamping member may be insulation-processed.

Further, the movable body according to the aforementioned aspect may further include a fuel cell casing in which the fuel cell stack is housed, and the fuel cell casing may have holes through which the first connection portion and the second connection portion pass.

The clamping member may be provided on the side face of the power generation stack body inside the fuel cell casing.

In the aforementioned aspect, the movable body may be a vehicle.

A second aspect of the invention relates to a method for mounting a fuel cell stack in a movable body. The fuel cell stack includes: a power generation stack body formed by stacking a plurality of power generation bodies; two end plates between which the power generation stack body is clamped in the direction in which the power generation bodies are stacked; and clamping members that are provided on respective side faces of the power generation stack body and that extend between the two end plates in such a manner that the two end plates are firmly connected to each other. According to the method, at least one of the two end plates is connected to a structural body that constitutes a body or a frame of the movable body, and the clamping members and the structural body are connected to each other at positions that are symmetrical with respect to the fuel cell stack.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIG. 1 is a view illustrating a manner in which a fuel cell stack is mounted in a vehicle according to a first embodiment of the invention;

FIGS. 2A, 2B and 2C are views illustrating a detailed manner in which the fuel cell stack is mounted in the vehicle;

FIG. 3 is a view illustrating other alternative positions at which the fuel cell stack is fitted to a vehicle frame; and

FIGS. 4A, 4B and 4C are views illustrating a detailed manner in which the fuel cell stack is mounted in the vehicle according to a second embodiment of the invention.

### DETAILED DESCRIPTION OF THE EMBODIMENTS

### A. First Embodiment of the Invention

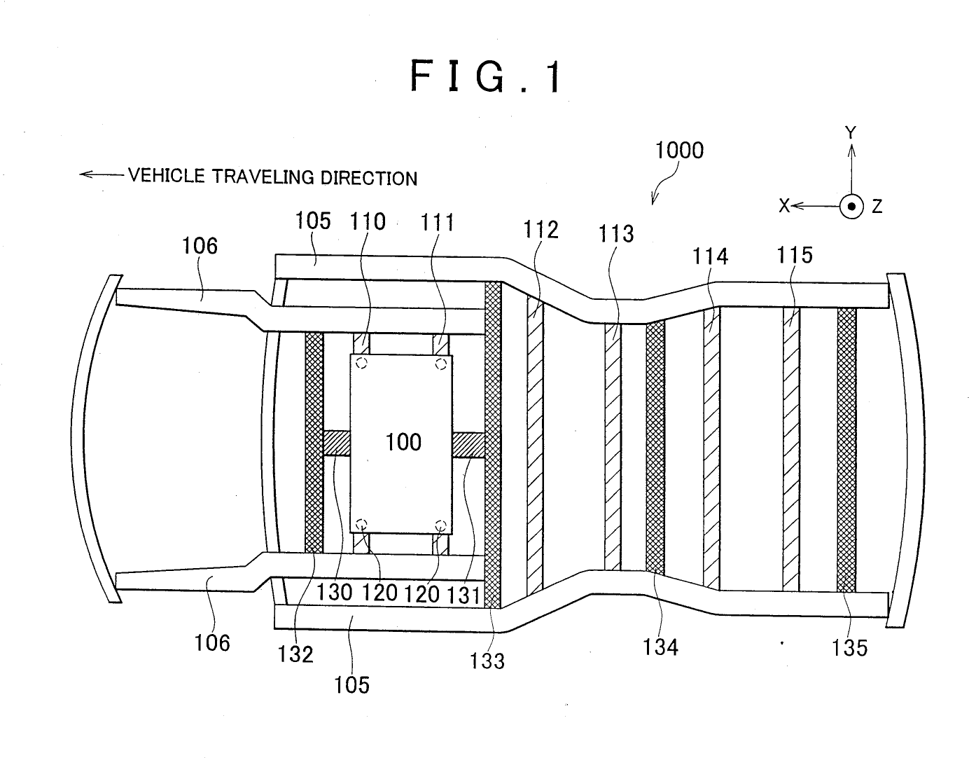

FIG. 1 is a view illustrating a manner in which a fuel cell stack 100 is mounted in a vehicle according to a first embodiment of the invention. A vehicle frame 1000, which is a basic structure of the vehicle, includes a pair of side members 105, a pair of side members 106, and cross members 110 to 115. The cross members 110 and 111 are disposed between the pair of side members 105, and cross members 112 to 115 are disposed between the pair of side members 106. Further, a partition 132 is provided between the pair of side members 106, and partitions 133 to 135 are provided between the pair of side members 106. The partitions 132 to 135 are part of a vehicle body, and partitions off the spaces formed within the vehicle frame 1000. The fuel cell stack 100 is disposed on the cross members 110 and 111, and is connected to the cross members 110 and 111 via first connection portions 120. Second connection portions 130 and 131 are provided between the fuel cell stack 100 and the partitions 132 and 133, respectively. The second connection portion 130 connects the fuel cell stack 100 to the partition 132, and the second connection portion 131 connects the fuel cell stack 100 to the partition 133. It should be noted that the structure of the vehicle frame 1000 shown in FIG. 1 is just an example, and the invention may be applied to a vehicle that has another structure.

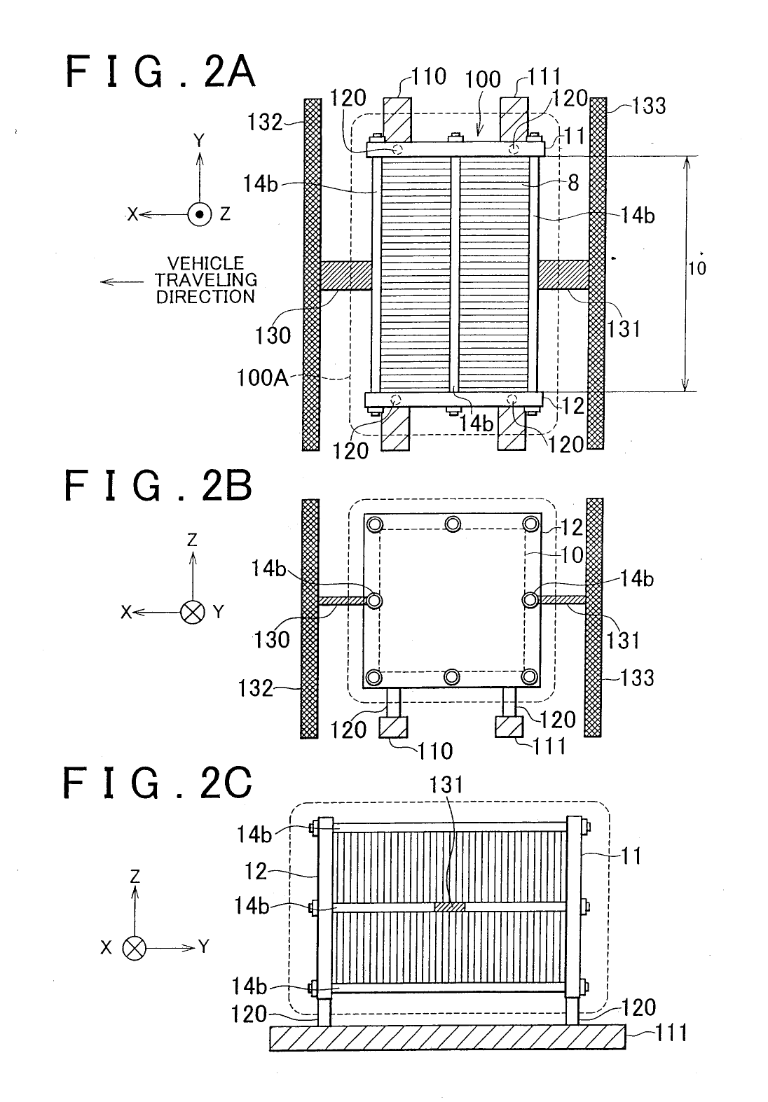

FIGS. 2A, 2B and 2C are views illustrating the detailed manner in which the fuel cell stack 100 is mounted in the vehicle. FIGS. 2A, 2B, and 2C are plan views showing the fuel cell stack 100 as viewed in the Z direction (vertical direction), the Y direction (vehicle-width direction), and the X direction (direction in which the vehicle travels (hereinafter, referred to as “vehicle traveling direction”)), respectively. Although structural members other than the structural members shown in FIG. 2, for example, side members, are provided in the vehicle, the structural members that are not connected to the fuel cell stack 100 are omitted from the figures for simplicity.

The fuel cell stack 100 is housed in a fuel cell casing 100A, and includes a power generation stack body 10, end plates 11 and 12, and clamping rods 14b. The power generation stack body 10 includes a plurality of power generation bodies 8 that generate electric power through an electrochemical reaction. The power generation bodies 8 are stacked in the direction substantially perpendicular to the vehicle traveling direction. The power generation body 10 is clamped between the end plates 11 and 12 in the direction in which the power generation bodies 8 are stacked. It should be noted that one of the end plates 11 and 12 has, for example, holes or pipes, through which fuel gas or the like flows. However, in order to simplify the figures, these holes or pipes are omitted from the figures. The clamping rods 14b are disposed so as to connect the end plates 11 and 12 to each other, and used to apply compressive stress to the power generation stack body 10 in the direction in which the power generation bodies 8 are stacked. The clamping rods 14b may be insulation-processed so that a short circuit does not occur in the power generation stack body 10. Alternatively, insulation members (not shown) may be provided between the power generation stack body 10 and the respective clamping rods 14b.

The first connection portions 120 connect the cross members 110 and 111, which are part of the structural members of the vehicle, to the end plates 11 and 12. The first connection portions 120 support the fuel cell stack 100 and fix the fuel cell stack 100 onto the cross members 110 and 111, which are the structural members of the vehicle. The second connection portions 130 and 131 extend from the fuel cell stack 100 to the partitions 132 and 133, which constitute part of the vehicle body, respectively, in the direction substantially perpendicular to the direction in which the power generation bodies 8 are stacked. The second connection portion 130 connects the corresponding clamping rod 14b to the partition 132, and the second connection portion 131 connects the corresponding clamping rod 14b to the partition 133. The first connection portions 120 and the second connection portions 130 and 131 may be made of shock-resistant material, for example, metal. Further, the fuel cell casing 100A may have holes through which the first connection portions 120 and the second connection portions 130 and 131 pass.

In the fuel cell stack 100 that is mounted in the vehicle in the above-described manner, if a shearing force is generated between adjacent power generation bodies 8 due to, for example, vibration of the vehicle, the clamping rods 14b, which are provided on the side faces of the power generation stack body 10, restrict the power generation bodies 8 from moving in the direction in which the shearing force is directed. Therefore, it is possible to suppress occurrence of the situation in which the power generation bodies 8 are out of proper alignment. Further, even if a shearing force that is generated between the adjacent power generation bodies 8 is too large to restrict the movement of the power generation bodies 8 by using only the clamping rods 14b, the partitions 132 and 133 and the second connection portions 130 and 131 support the clamping rods 14b according to the first embodiment of the invention. Therefore, it is possible to restrict the movement of the power generation bodies 8 to suppress occurrence of the situation in which the power generation bodies 8 are out of proper alignment. In particular, even if a large impact is applied to the vehicle body, this structure makes it is possible to suppress occurrence of the situation in which the power generation bodies 8 are out of proper alignment. Note that, it is preferable that the second connection portions 130 and 131 be disposed at symmetrical positions with respect to the fuel cell stack 100 so that the second connection portions 130 and 131 face each other across the fuel cell stack 100. With this structure, the fuel cell stack 100 is supported in a balanced manner even if, for example, impacts are applied to the fuel cell stack 100 in various directions, or a force, which acts in the opposite direction to the direction in which the impact is applied, is applied to the fuel cell stack 100 in reaction to the impact applied.

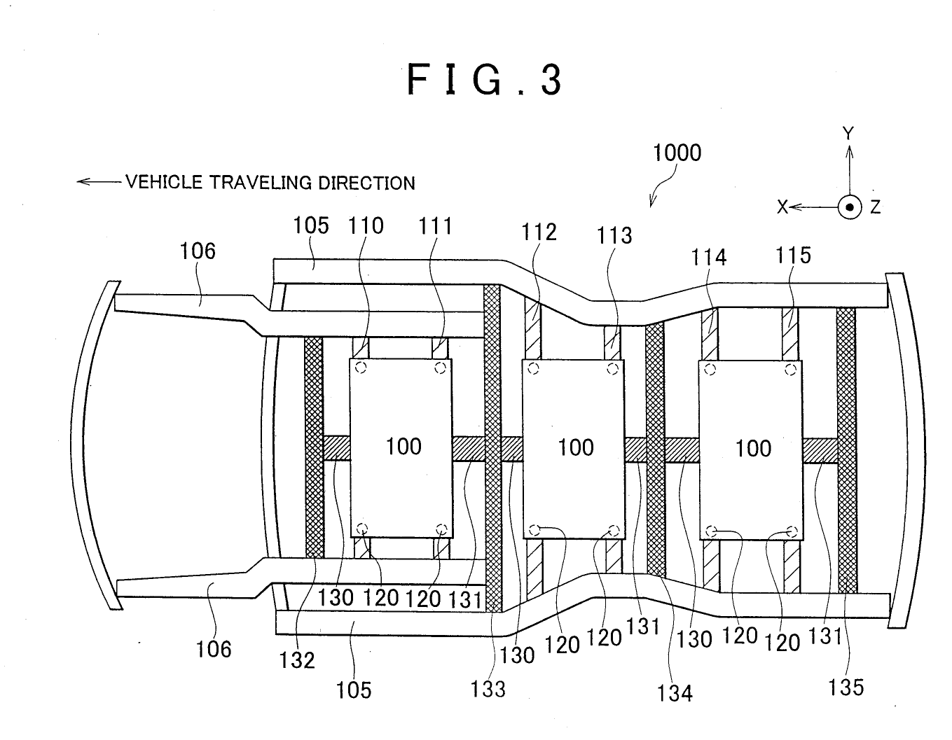

FIG. 3 is a view illustrating other alternative positions at which the fuel cell stack 100 is fitted to the vehicle frame 1000. As shown in FIG. 3, the fuel cell stack 100 may be mounted in the vehicle at any selected position as long as the fuel cell stack 100 is surrounded by the structural members of the vehicle, such as the cross member 100 and the partition 132.

According to the first embodiment of the invention, because each of the end plates 11 and 12 of the fuel cell stack 100 is connected to the cross members 110 and 111, which are structural members of the vehicle, via the first connection portions 120, it is possible to support the fuel cell stack 100 in the vehicle. Further, the partitions 132 and 133, which are part of the vehicle body, are connected to the respective clamping rods 14b of the fuel cell stack 100 via the second connection portions 130 and 131. Therefore, it is possible to suppress occurrence of the situation in which the power generation bodies 8 of the fuel cell stack 100 are out of proper alignment due to, for example, an impact applied from the vehicle body or vibration of the vehicle body.

### B. Second Embodiment of the Invention

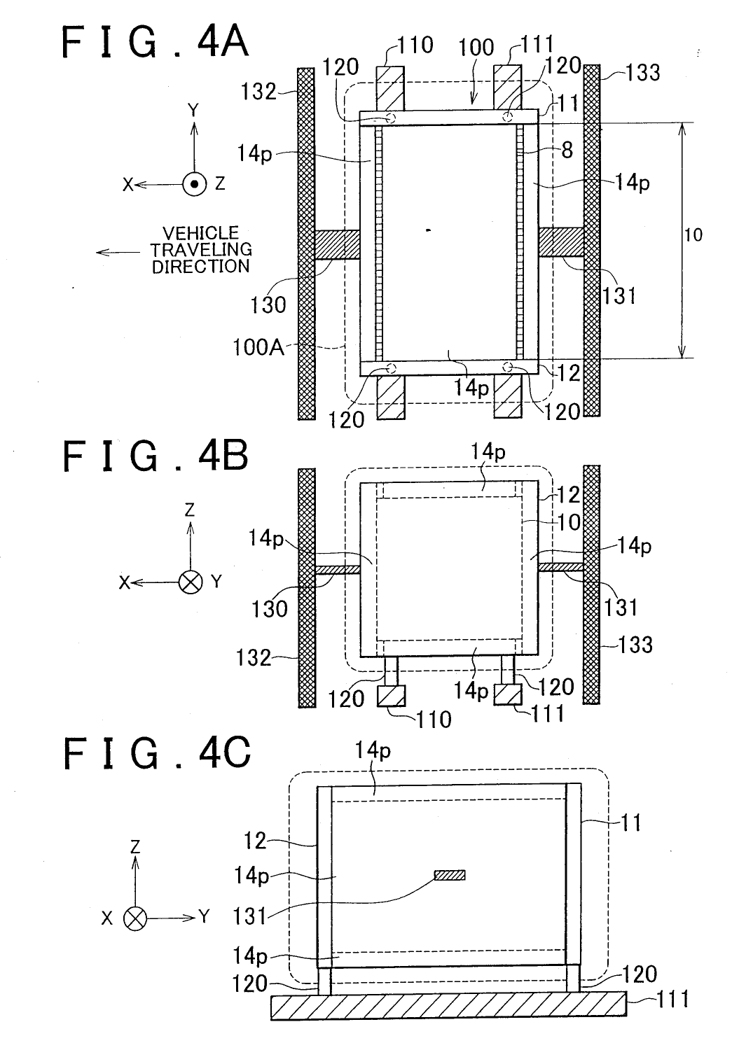

FIGS. 4A, 4B and 4C are views illustrating the detailed manner in which the fuel cell stack 100 is mounted in the vehicle according to a second embodiment of the invention. The manner according to the second embodiment differs from the manner according to the first embodiment shown in FIG. 2 only in that the end plates 11 and 12 are firmly connected to each other by clamping plates 14p having a substantially flat plate shape, instead of by the clamping rods 14b. Other structural members in the second embodiment of the invention are the same as those in the first embodiment of the invention.

When the end plates 11 and 12 are firmly connected to each other by the clamping plates 14p as described above and the clamping plates 14p are connected to the second connection portions 130 and 131, it is possible to suppress occurrence of the situation in which the power generation bodies 8 of the fuel cell stack 100 are out of proper alignment, as in the first embodiment of the invention. In particular, the clamping plate 14p in the second embodiment has a surface area larger than that of the clamping rod 14b. This offers a higher degree of flexibility in arrangement of the second connection portions 130 and 131.

### C. Modification Examples

It should be noted that the invention is not limited to the aforementioned embodiments, and may be implemented in various other embodiments within the scope of the invention. For example, the aforementioned embodiments may be modified in the following manner.

### C1. Modification Example 1

According to the aforementioned embodiments of the invention, the direction in which the power generation bodies 8 of the fuel cell stack 100 are stacked is substantially perpendicular to the vehicle traveling direction. Alternatively, the fuel cell stack 100 may be mounted in the vehicle in such a manner that the direction in which the power generation bodies 8 are stacked is substantially parallel to the vehicle traveling direction.

C2. Modification Example 2

According to the aforementioned embodiments of the invention, the second connection portions 130 and 131 are disposed at the symmetrical positions with respect to the fuel cell stack 100 so that the second connection portions 130 and 131 face each other across the fuel cell stack 100. However, this is only one exemplary structure. Only one second connection portion may be provided, or three or more second connection portions may be provided.

### C3. Modification Example 3

According to the aforementioned embodiments of the invention, the second connection portions 130 and 131 are connected to the partitions 132 and 133, respectively. However, the second connection portions 130 and 131 may be connected to any selected structural members of the vehicle, such as the cross members, instead of to the partitions 132 and 133.

### C4. Modification Example 4

According to the aforementioned embodiments of the invention, there are spaces between the clamping rods 14b or the clamping plates 14p, and the partitions 132 and 133, and the second connection portions 130 and 131 are provided in the spaces as members used to connect the clamping rods 14b or the clamping plates 14p to the partitions 132 and 133. Alternatively, the distance between the partition 132 and the partition 133 may be made equal to the width of the fuel cell stack 100, and the clamping rods 14b or the clamping plates 14p may be directly connected to the partitions 132 and 133.

### C5. Modification Example 5

According to the aforementioned embodiments of the invention, the clamping rods 14b or the clamping plates 14p are formed separately from the second connection portions 130 and 131. Alternatively, the clamping rods 14b or the clamping plates 14p may be formed integrally with the second connection portions 130 and 131.

Furthermore, the invention may be implemented in various other embodiments. For example, the invention may be applied to a fuel cell and a fuel cell system, and may also be applied to a movable body, such as a vehicle, an aircraft, or a robot, in which such fuel cell or fuel cell system is mounted, or a method of manufacturing such fuel cell or fuel cell system.

1. A movable body, comprising:
a fuel cell stack that includes: a power generation stack body formed by stacking a plurality of power generation bodies; two end plates between which the power generation stack body is clamped in a direction in which the power generation bodies are stacked; and a clamping member that is provided on a side face of the power generation stack body and that extends between the two end plates in such a manner that the two end plates are firmly connected to each other;
a structural body that constitutes a body or a frame of the movable body;
a first connection portion that connects at least one of the two end plates to the structural body; and
a second connection portion that connects the clamping member to the structural body.

2. The movable body according to claim 1, wherein a plurality of the clamping members, each of which has a rod-shape, is provided.

3. The movable body according to claim 1, wherein the clamping member is a flat plate-shaped member.

4. The movable body according to claim 1, wherein a plurality of the second connection portions is provided at positions that are symmetrical with respect to the fuel cell stack so that the second connection portions face each other across the fuel cell stack.

5. The movable body according to claim 1, wherein the power generation bodies are stacked in a direction parallel to a direction in which the movable body travels to form the power generation stack body.

6. The movable body according to claim 1, wherein the power generation bodies are stacked in a direction perpendicular to a direction in which the movable body travels to form the power generation stack body.

7. The movable body according to claim 1, wherein:
the structural body includes a pair of side members, a cross member that extends between the side members, and a partition that is provided between the side members; and
the first connection portion connects at least one of the two end plates to the cross member, and the second connection portion connects the clamping member to the partition.

8. The movable body according to claim 1, wherein at least one of the first connection portion and the second connection portion is made of metal.

9. The movable body according to claim 1, wherein the clamping member is insulation-processed.

10. The movable body according to claim 1, further comprising a fuel cell casing in which the fuel cell stack is housed, wherein the fuel cell casing has holes through which the first connection portion and the second connection portion pass.

11. The movable body according to claim 10, wherein the clamping member is provided on the side face of the power generation stack body inside the fuel cell casing.

12. The movable body according to claim 1, the movable body is a vehicle.

13. A method for mounting a fuel cell stack in a movable body, the fuel cell stack including a power generation stack body formed by stacking a plurality of power generation bodies; two end plates between which the power generation stack body is clamped in a direction in which the power generation bodies are stacked; and clamping members that are provided on respective side faces of the power generation stack body and that extend between the two end plates in such a manner that the two end plates are firmly connected to each other, the method comprising:
connecting at least one of the two end plates to a structural body that constitutes a body or a frame of the movable body; and
connecting the clamping members and the structural body to each other at positions that are symmetrical with respect to the fuel cell stack.
